(19) United States
(12) Patent Application Publication
(10) Pub. No.: US 2003/0182273 A1
(43) Pub. Date: Sep. 25, 2003

(54) Method and apparatus for generating a query object

(76) Inventors: Robert N. Goldberg, Emerald Hills, CA (US); Yury Kamen, Foster City, CA (US); Syed M. Ali, Sunnyvale, CA (US); Bruce K. Daniels, Capitola, CA (US)

Correspondence Address: ROSENTHAL & OSHA L.L.P. / SUN, 1221 MCKINNEY, SUITE 2800, HOUSTON, TX, 77010, US

(21) Appl. No.: 10/104,851

(22) Filed: Mar. 22, 2002

(51) Int. Cl. G06F 7/00

(52) U.S. Cl. 707/3

(57) ABSTRACT

A method for generating a query object, comprising creating a query object specification defining the query object, creating an object-database mapping, creating a platform specification defining a platform upon which the query object is executed, and generating the query object using the query object specification, the platform specification, and the object-database mapping.

### BACKGROUND OF INVENTION

Modern enterprise applications are typically implemented as multi-tier systems. Multi-tier systems serve the end-user through a chain of client/server pairs. In general, they include a user interface at the front end, a database management system (DBMS) at the back end, and an application server in between the user interface and the database. Depending on the component providing the user interface, an additional middle tier may exist between the user interface and the application server. For example, if the user interface is provided by a web browser, a web server would exist between the web browser and the application server. The web browser would send requests to the web server, and the web server would interact with application data in the database through the application server in order to generate a response to send to the web browser.

FIG. 1 shows an example of a four-tiered system that includes a user interface tier (2), a web server tier (4), an application server tier (6), and a data tier (8). The user interface tier (2) is the layer of interaction and typically includes a form-like graphical user interface (GUI) displayed by a display component, typically a web browser (10). The web server tier (4) includes web components (12) hosted on a web server (14). The web components (12) generate the content displayed by the web browser (10). The application server tier (6) includes application components (16) hosted on an application server (18). The application components (16) model the business rules, typically through interaction with application data. The data tier (8) includes a persistent data store, typically a database management system (DBMS) (22) and a database (20).

Modern enterprise applications typically work with persistently stored data by mapping the data into one or more objects. Once the enterprise application has retrieved the desired object(s), the enterprise application may manipulate the objects using attributes and methods defined in the object. Within the context of an enterprise application based on persistent data, the first step in locating the desired object(s) is to issue some kind of query to a DBMS system. For example, in an online bookstore application, the first step may be to locate all the book orders that the current customer has made previously, where each book order is represented as an object.

It is generally not satisfactory to instantiate all book orders into objects, and then iterate through all book orders to find the book orders made by the current user. In particular, if there are many customers, a potentially large number of objects may need to be instantiated just to determine that the objects are not needed. Thus, to find the desired orders, it is typically desirable to submit a query to the DBMS system that identifies only those book orders submitted by the current user, and then instantiate the corresponding book order objects.

One prior art method of implementing a DBMS query is to use a query object (see, U.S. Pat. No. 6,076,092). FIG. 2 illustrates a typical query object. A query object (19) typically includes a method interface (24), a method implementation (26), and a DBMS Access/Connection Manager (28). The method interface (24) includes functionality to allow an application (30) to interface with the query object (19). The method implementation (26) encapsulates the functionality of the query object (19). Typically, the method implementation (26) includes functionality to take a method call (32) from the application (30) and map it to a platform-specific query (34). Additionally, the method implementation (26) includes functionality to process a platform-specific query result (36), obtained from the database (20) via the DBMS (22), to produce a method call result (38) that can be utilized by the application (30). The DBMS Access/Connection Manager (28) includes platform-specific code to access the DBMS (22) and manage a connection with the DBMS (22).

### SUMMARY OF INVENTION

In general, in one aspect, the invention relates to a method for generating a query object, comprising creating a query object specification defining the query object, creating an object-database mapping, creating a platform specification defining a platform upon which the query object is executed, and generating the query object using the query object specification, the platform specification, and the object-database mapping.

In general, in one aspect, the invention relates to a method for reusing platform-independent query comprising defining a platform-independent query, defining an object-database mapping, creating a first platform specification defining a first platform upon which the query object is executed, generating a first query object using the platform-independent query, the first platform specification, and the object-database mapping, creating a second platform specification defining a second platform upon which the query object is executed, and generating a second query object using the platform-independent query, the second platform specification, and the object-database mapping.

In general, in one aspect, the invention relates to an apparatus for generating a query object, comprising means for creating a query object specification defining the query object, means for creating an object-database mapping, means for creating a platform specification defining a platform upon which the query object is executed, and means for generating the query object using the query object specification, the platform specification, and the object-database mapping.

In general, in one aspect, the invention relates to an apparatus for reusing platform-independent query comprising means for defining a platform-independent query, means for defining an object-database mapping, means for creating a first platform specification defining a first platform upon which the query object is executed, means for generating a first query object using the platform-independent query, the first platform specification, and the object-database mapping, means for creating a second platform specification defining a second platform upon which the query object is executed, and means for generating a second query object using the platform-independent query, the second platform specification, and the object-database mapping.

Other aspects and advantages of the invention will be apparent from the following description and the appended claims.

### BRIEF DESCRIPTION OF DRAWINGS

FIG. 1 illustrates a typical four-tier system.

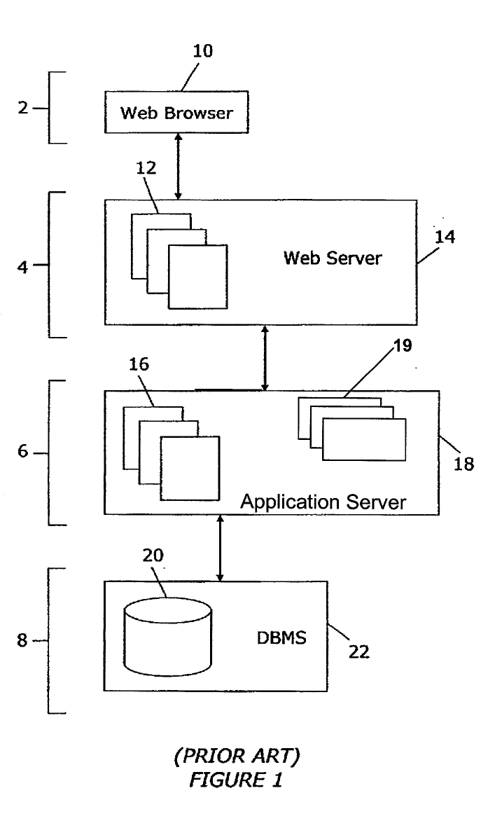

FIG. 2 illustrates a typical query object.

FIG. 3 illustrates a typical computer system.

FIG. 4 illustrates a flow diagram for generating a query object in accordance with one embodiment of the invention.

### DETAILED DESCRIPTION

Exemplary embodiments of the invention will be described with reference to the accompanying drawings. Like items are denoted by like reference numerals throughout the drawings for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The invention relates to a method for generating a query object. Further, the invention relates to using a platform-independent query language to specify a query within the generated object. Further, the invention relates to using a platform specification to define the platform upon which the query object is to be executed.

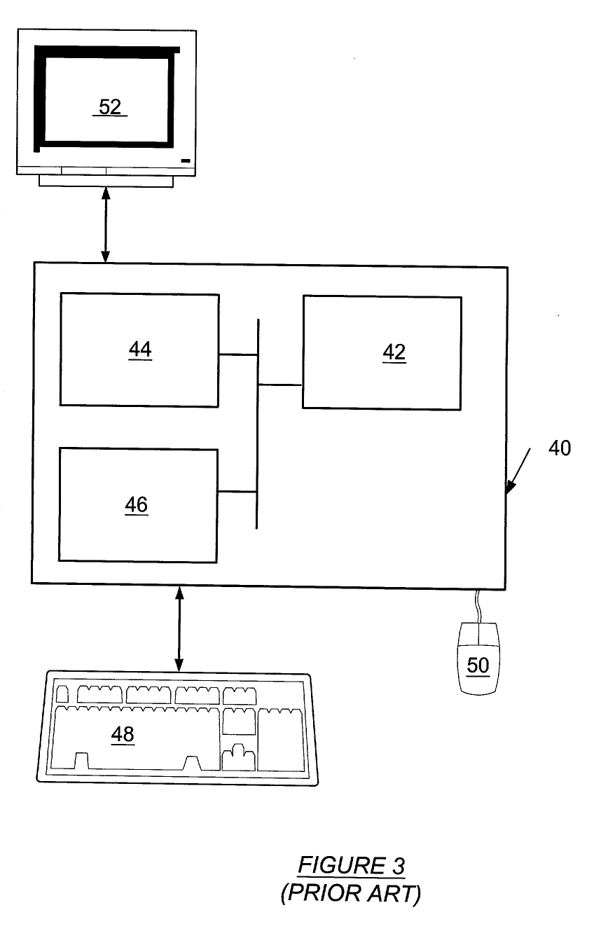

The present invention may be implemented on virtually any type computer regardless of the platform being used. For example, as shown in FIG. 3, a typical computer (40) includes a processor (42), associated memory (44), a storage device (46), and numerous other elements and functionalities typical of today's computers (not shown). The computer (40) may also include input means, such as a keyboard (48) and a mouse (50), and output means, such as a monitor (52). Those skilled in the art will appreciate that these input and output means may take other forms in an accessible environment.

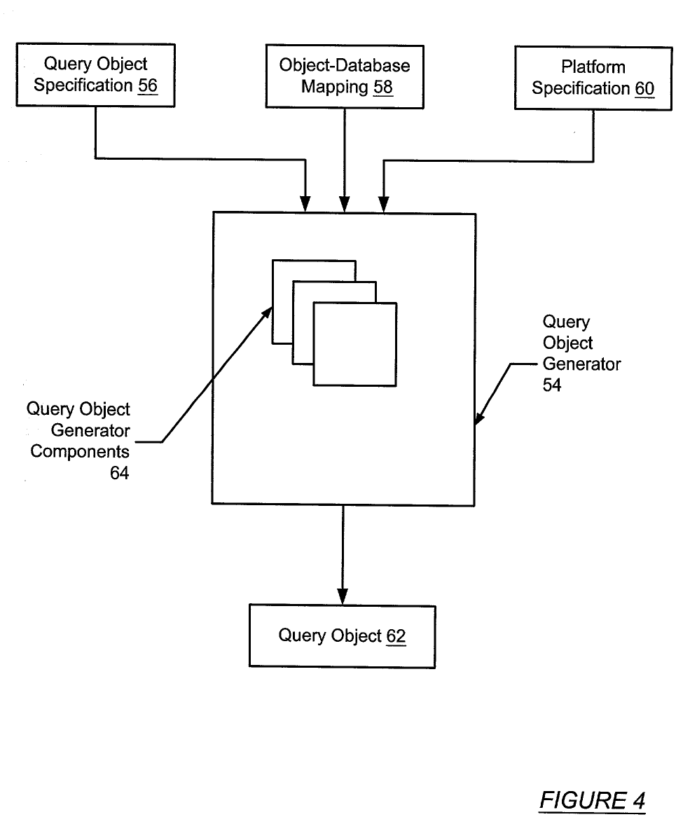

FIG. 4 illustrates a flow diagram for generating a query object in accordance with one embodiment of the invention. The query object generator (QOG) (54) takes a query object specification (QOS) (56), an object-database mapping (ODBM) (58) and a platform specification (PS) (60) as input and generates a query object (62).

The QOS (56) defines a query method in a platform-independent manner. In one embodiment of the invention, a platform-independent query language is used to define the query method. Further, the QOS (56) uses a standard format to specify attributes and attribute types. The platform-independent query language and the standard format to specify attributes and attribute types allows the QOS (56) to be implemented on any relational or object-oriented database, such as CMP-based Enterprise Java™ Beans, Java™ Database Object (JDO) objects, object-relationally mapped Java™ objects, etc. Further, the platform-independent query language and the standard format to specify attributes and attribute types allows a particular QOS (56) to be reused to generate a number of platform specific query objects. For example, consider the case where a QOS is used to initially generate a query object for a particular DBMS. If the underlying DBMS is subsequently changed, the same QOS may be used to generate a new query object that may be used with the new DBMS.

In one embodiment of the invention, the QOS (56) includes functionality to allow a user to specify the desired method signature (i.e., a definition of the input and/or output parameters for a given method), thereby streamlining the process of declaring the types of the input attributes in the QOS (56). For example, the user might specify the query methods signature in Java™ as: Collection getMyOrders(int myId), and the corresponding query as: SELECT bko FROM BookOrder bko WHERE custId=:myId.

From this query, the invention generates the complete implementation of the method getMyOrders(int myId), including the code to interface to the desired database, the code to check if the returned objects have already been instantiated, the code to instantiate them if necessary, the code to collect the objects into a collection, and the code to return the collection as the method's result. Thus, the query is treated as a complete method implementation in the invention. Thus, the user need not know how to invoke the query, pass the parameters to the query correctly, or collect the results, map them into instantiated objects, and return the collection.

In one embodiment of the invention, the QOS (56) may specify a transient object. The transient object refers to a new object created within the QOS (56) during runtime. The transient object is typically present, in temporary storage, for the duration of the method and potentially for a longer duration if so implemented within the application. Once the duration has expired or the application is exited, the transient object is removed from the temporary storage.

For example, consider the following method signature: Collection copyOrders(int existingId, int newId), and the accompanying query: SELECT new BookOrder(newId,bko.book,bko.quantity) FROM BookOrder bko WHERE custId=:existingId. In this example, a new object “BookOrder” is defined where the result of this query method is a collection of new, transient objects of type BookOrder.

The following discussion details three platform-specific queries generated from the same platform-independent query. The following code sample defines a method signature and a corresponding query.

### Code Sample 1: Method Signature and Platform-Independent Query

| | |
|---|---|
| 1 | factory method expensiveLineItems( Decimal price, |
| | String billToName ) |

| | |
|---|---|
| 2 | returns List of LineItem |

| | |
|---|---|
| 3 | QUERY ( SELECT li |

| | |
|---|---|
| 4 | FROM LineItem li |
| 5 | WHERE li.masterOrder.billToName = :billToName |

| | |
|---|---|
| 6 | AND li.unitPrice > :price ) |

In the code sample listed above, referred to as “Code Sample 1”, lines 1-2 define the method signature for the “expensiveLineItems” method. In particular, the method requires two input attributes, namely price and billToName, and returns a List of LineItem. Lines 3-6 define a corresponding platform-independent query. In particular, the query selects all the LineItem objects that meet the criteria defined in lines 5-6.

The following code sample defines a query in Java™ Data Object Query Language (JDOQL) using the platform-independent query defined in Code Sample 1.

### Code Sample 2: JDOQL Query

| | |
|---|---|
| 1 | SELECT li |

| | |
|---|---|
| 2 | FROM LineItem li |
| 3 | WHERE li.masterOrder.billToName = = billToName_param |

| | |
|---|---|
| 4 | && li.unitPrice > price_param |

In the code sample listed above, referred to as “Code Sample 2”, it is not possible, as a limitation of JDOQL, to have parameters with the same name as an attribute; thus, when the platform-independent query is converted to a JDO query, the method parameter names “billToName” and “price” are converted to “billToName_param” and “price_param”. Further, the “:” is removed because JDOQL does not use that syntax for parameters. Additionally, code is generated to invoke the query via the JDO query mechanism at runtime, by defining JDO parameters “billToName_param” and “price_param”, and to pass the values specified in the method parameters “billToName” and “price.” Further, the single “=” used for equality testing in the platform-independent query language was translated into “==”, which is the syntax required by JDOQL. Additionally, the conductive operator “AND” in the platform-independent query language was translated into “&&”, which is the syntax required by JDOQL.

The following code sample defines a query in Enterprise Java™ Bean Query Language (EJBQL) using the platform-independent query defined in Code Sample 1.

### Code Sample 3: JDOQL Query

| | |
|---|---|
| 1 | SELECT OBJECT(li) |

| | |
|---|---|
| 2 | FROM LineItemBean li |
| 3 | WHERE li.masterOrder.billToName = ?2 |

| | |
|---|---|
| 4 | AND li.unitPrice > ?1 |

In the code sample listed above, referred to as “Code Sample 3”, the selection of objects at the “top level,” in accordance with EJBQL syntax, must be qualified by the “OBJECT ( )” operator. Further, in EJBQL, parameters must be identified using a leading “?” followed by a number representing the parameter's ordinal position in the parameter list. In this case, the “billToName” parameter is the second method parameter, and the “price” parameter is the first method parameter. Additionally, in EJBQL, the name used for the “extent” containing all objects of a particular type, e.g., LineItem objects, is (by convention) the abstract implementation interface, e.g., “LineItemBean”; thus, the invention translates “LineItem” in the FROM clause to “LineItemBean”.

The following code sample defines a query in Structured Query Language to be used with a Java™ Database Connectivity (JDBC) implementation using the platform-independent query defined in Code Sample 1.

### Code Sample 4: SQL Query for JDBC Implementation

| | |
|---|---|
| 1 | SELECT OBJECT(li) |
| 2 | FROM LineItems li, PurchaseOrders po |
| 3 | WHERE po.billToName = ? |
| 4 | AND li.unitPrice > ? |
| 5 | AND li.masterOrder_orderId = po.orderId |

In the code sample listed above, referred to as “Code Sample 4”, the parameters are identified, in accordance with JDBC syntax, using a “?”, and the corresponding parameters must be passed to the JDBC runtime Application Programming Interface in the correct order. Further, in SQL, it is necessary to join the LineItems and PurchaseOrders tables in the FROM clause to navigate from a LineItem to the master order's “billToName” field. Additionally, in SQL, the name of the “extent” used for the object must be mapped to the underlying table name, e.g., “LineItems” for object “LineItem.”

Returning to FIG. 4, the ODBM (58) defines how each attribute within a business object specification is mapped to the underlying database schema. The business object specification is disclosed in U.S. Provisional Application Serial No. 60/354,771 filed Feb. 6, 2002, entitled “Development and Generation of Enterprise Application Using a High-level Specification,” in the names of Bruce K. Daniels, Robert N. Goldberg, Yury Kamen, and Syed M. Ali.

For example, in Code Sample 1, the platform-independent query retrieves the LineItem objects that meet the specific criteria defined in the query. The platform-independent query is defined using attributes of the business objects used within the enterprise application. However, the query search through a database may not correspond one-to-one with the business objects specification. Thus, the QOG (54) requires a mapping to specify which business object attribute corresponds to a particular column in a table. Further, the OBDM (58) allows the underlying database schema to change without affecting the query method, and vice versa.

The PS (60) defines the platform upon which the query object (62) is to be executed. Specifically, the PS (60) defines the particular DBMS that the query object interfaces with, and the application that the query object is interfacing with.

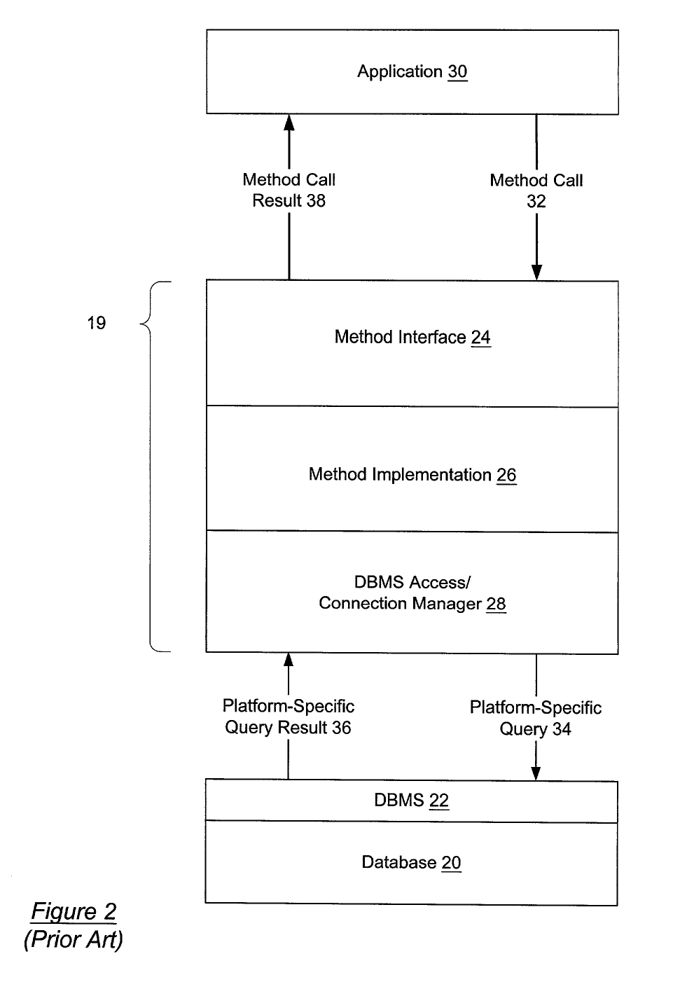

The QOG (54) includes query object generator components (QOGC) (64). The QOGC (64) encapsulate best-mode practices that are used to generate the resulting query object (62). Further, the QOGC (64) include functionality to interpret the QOS (56), the ODBM (58), and the PS (60) to generate the desired query object (62). For example, the QOGC (64) typically include functionality to generate the appropriate code for the DBMS Access/Connection Manager (28 in FIG. 2), and the method interface (24 in FIG. 2).

In one embodiment of the invention, the query object (62) generated by the QOG (54) includes a method implementation that includes functionality to process a collection of objects. For example, in addition to generating a query object that returns a result set consisting of a list of attributes of primitive database types, such as string or date, the invention generates a query object that returns an object or collection of objects of the appropriate type. In one embodiment of the invention, this above described functionality is achieved by determining if an object in the result is already instantiated. If the object is already instantiated, then the query object uses instantiated object, instead of instantiating an alias for the object.

The invention may include one or more of the following advantages. The ability to specify a query without specific knowledge about the platform the query is to be implemented on. The ability to generate a query object using only platform-independent knowledge.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating a query object, comprising:
creating a query object specification defining the query object;
creating an object-database mapping;
creating a platform specification defining a platform upon which the query object is executed; and
generating the query object using the query object specification, the platform specification, and the object-database mapping.

2. The method of claim 1, wherein the query object specification uses a platform-independent object-based query language to define the query object specification.

3. The method of claim 2, wherein the platform-independent object-based query language comprises a means to specify a parameter and a parameter type.

4. The method of claim 1, the query object comprising a logic method that returns an object.

5. The method of claim 1, the query object comprising a logic method that returns a collection of objects.

6. The method of claim 1, the query object specification comprising a method signature.

7. The method of claim 1, wherein the query object is generated using a query object generator.

8. The method of claim 7, the query object generator comprising a plurality of query object generator components.

9. The method of claim 8, at least one of the plurality of components comprising a database management system access generator component generating a platform-specific access manager.

10. The method of claim 8, at least one of the plurality of components comprising a connection manager generator component generating a platform-specific connection manager.

11. The method of claim 1, the object-database mapping comprising an object-relational mapping.

12. The method of claim 1, wherein the object-database mapping is created using a business object specification.

13. The method of claim 1, wherein the query object specification defines a method signature.

14. The method of claim 13, the method signature comprising a transient object definition.

15. A method for reusing platform-independent query comprising:
defining a platform-independent query;
defining an object-database mapping;
creating a first platform specification defining a first platform upon which the query object is executed;
generating a first query object using the platform-independent query, the first platform specification, and the object-database mapping;
creating a second platform specification defining a second platform upon which the query object is executed; and
generating a second query object using the platform-independent query, the second platform specification, and the object-database mapping.

16. An apparatus for generating a query object, comprising:
means for creating a query object specification defining the query object;
means for creating an object-database mapping;
means for creating a platform specification defining a platform upon which the query object is executed; and
means for generating the query object using the query object specification, the platform specification, and the object-database mapping.

17. An apparatus for reusing platform-independent query comprising:
means for defining a platform-independent query;
means for defining an object-database mapping;
means for creating a first platform specification defining a first platform upon which the query object is executed;
means for generating a first query object using the platform-independent query, the first platform specification, and the object-database mapping;
means for creating a second platform specification defining a second platform upon which the query object is executed; and
means for generating a second query object using the platform-independent query, the second platform specification, and the object-database mapping.
